(19) United States
(12) Patent Application Publication
(10) Pub. No.: US 2015/0104044 A1
(43) Pub. Date: Apr. 16, 2015

(54) Throat-Vibration-Type Microphone and Communication Hands-Free Device Containing Same

(71) Applicant: NEO-VICTORY TECHNOLOGY CO., LTD., Tainan City (TW)

(72) Inventors: Shio-Shiin Lee, Tainan City (TW); Chih-Hsien Liang, Tainan City (TW); Yu-An He, Tainan City (TW)

(21) Appl. No.: 14/384,390

(22) PCT Filed: Mar. 27, 2013
(86) PCT No.: PCT/CN2013/073257

§ 371 Date: Sep. 11, 2014

(30) Foreign Application Priority Data
Mar. 27, 2012 (CN) 201210083944.0

(51) Int. Cl. H04R 1/46; H04R 1/08

(52) U.S. Cl. CPC H04R 1/46; H04R 1/08; H04R 2420/07
USPC 381/120

(57) ABSTRACT

A throat-vibration-type sensor includes a ceramic sheet and a copper sheet received in a box body, wherein the ceramic sheet and the copper sheet are electrically connected to an amplification circuit for voice communications. The volume and thickness of the throat-vibration-type sensor is reduced, the cost thereof is reduced, the assembly thereof is easy, and the reception effect is increased. The throat-vibration-type sensor is combined with a communication hand-free device which includes a control circuit board, a sound amplification device and a battery unit. The throat-vibration-type sensor is used for relieving the interference of external noise. The communication hand-free device combined with the throat-vibration-type sensor avoids the inability of identifying a voice signal because of a wind shear sound caused by a high moving speed of a wearer, to improve the overall utilization efficiency of the communication hand-free device.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

1. Field of Invention

The present invention relates to a communication device, and more particularly to a throat-vibration-type microphone and a hand-free communication device with the throat-vibration-type microphone, which has a simplified configuration and is implemented individually or in combination with the hand-free communicate device, so as to lower the manufacturing costs, to assemble easily, and to improve the audio reception effect.

2. Description of Related Arts

Due to the size of well-known throat-vibration-type microphone is relatively large, the throat-vibration-type microphone cannot be installed in the nose supporting pad of the spectacles. In other words, the structure of the throat-vibration-type microphone must be designed to substantially minimize the size thereof in order to satisfy the customer's needs. In particular, its configuration for the vibration audio signal and its audio conductive materials cannot fit the requirements of the audio conduction near the nasal bone of the user. The relative prior arts have been disclosed in Taiwan Patent No. 444998, entitled “ceramic piezoelectric microphone, Taiwan Patent No. 462575, entitled “an improved structure of a throat-vibration-type microphone, and Taiwan Patent No. 549780, entitled “an improved structure of a throat-vibration-type microphone”.

In order to solve the above problems, the applicant of the present invention disclosed a nasal-bone conduction microphone in Taiwan Patent Publication No. 201006265, wherein the main objective of the above Taiwan Patent is to combine the throat-vibration-type microphone with the spectacles that the nasal-bone conduction microphone is placed on the nasal bone of the user for to detecting vibrations from the voices through the skin and bones for voice communication purposes. Since the nasal vibrato is clearer than the guttural vibrato, and the amplitude of the nasal vibrato is smaller than that of the guttural vibrato, the conduction of the noise is more sensitive. Therefore, the nasal-bone conduction microphone has done the structure simplification, sensitivity enhancement, and background noise isolation. In other words, the nasal-bone conduction microphone can substantially reduce its size to fit at the spectacles in order to locate the nasal-bone conduction microphone at the nasal bone for voice communication and for overcoming the aforementioned disadvantages of the prior arts

However, the above mentioned nasal-bone conduction microphone still has following drawbacks.

1. The volume and thickness thereof is not small enough to incorporate with the spectacles.

2. The audio reception and its sound quality are poor. Because the nasal bone vibrations are relatively small, the sound quality of the nasal-bone conduction microphone cannot be compared with that of the general air-conduction type microphone and throat-vibration type microphone.

3. The assembly of the nasal-bone conduction microphone is complicated due to the various mechanical components. All of the mechanical components must be installed precisely in order to achieve the best voice reception. In other words, the assembling quality becomes hard to control or maintain, so as to cause the low yield rate during the mass production.

In addition, comparing with the nasal-bone conduction microphone products, the size and the thickness of the existing throat-vibration-type microphone are relative larger, and the configuration of mechanical components thereof is complicated. Furthermore, the interior of the microphones as all above mentioned Taiwan Patent No. 444,998, 462,575, and 549,780 have foam bodies. If the foam bodies don't closely connect with other mechanical components during assembling, the voice reception of the throat-vibration-type microphone will be greatly reduced and will cause the distortion problems. FIG. 1 shows the frequency response diagram for the throat-vibration-type microphone with the foam bodies. In “Frequency response diagram”, the horizontal axis represents the frequency and the vertical axis represents the sensitivity to illustrate the quality of the voice reception of the microphone, wherein if the line segment is nearly formed as the horizontal straight line, the voice reception is better and less audio distortion will generate. As shown in FIG. 1, the throat-vibration-type microphone with foam bodies has poor voice reception and has audio distortion problems. Furthermore, Taiwan Patent No. I 317605, entitled “low noise, touching-vibration, and piezoelectric type microphone” provided a microphone comprising an inner spring for filtering the noise. However, such microphone also has bad voice reception and audio distortion problems, wherein its frequency response diagram is shown in FIG. 2.

Moreover, if the foregoing conventional throat-vibration-type microphone is incorporated with a hand-free communication device, the voice signals cannot be recognized due to the wind shear sound which caused by the rapid movement of the wearer.

Therefore, the conventional throat-vibration-type microphone highly needs to be improved.

### SUMMARY OF THE PRESENT INVENTION

A main object of the present invention is provided a throat-vibration-type sensor incorporated with a hand-free communication device to solve the technical problems of the prior arts of the nasal-bone conduction microphone and the throat-vibration type microphone which have the imperfect design of large volume and thickness, complicated structure, difficult for assembling, poor quality of audio receptions, and poor quality of sound defects, so as to provide an effective solution to improve the above technical problems of the prior arts.

According to the present invention, the foregoing and other objects and advantages are attained by a throat-vibration-type sensor which comprises a box body, a ceramic sheet, a copper sheet and an amplification circuit. The box body has an interior receiving cavity and an outer wall defining a flat platform at an inner side of the outer wall. The ceramic sheet is directly bonded on and overlapped with the platform within the receiving cavity of the box body, wherein the ceramic sheet is electrically connected to a positive electric wire. The copper sheet is bonded beneath and overlapped with the ceramic plate within the receiving cavity of the box body, wherein the copper sheet is electrically connected with a negative electric wire. The amplification circuit is electrically connected between the positive electric wire and the negative electric wire to electrically link to the ceramic sheet and the copper sheet respectively. The amplification circuit can be disposed outside the box or can be placed inside the box body. Therefore, by omitting the conventional conduction medium, i.e. foam bodies or springs, the overall size and thickness of the present invention can be substantially reduced, such that the structure of the present invention can be thinner comparing the existing one. Since the sound vibration is directly transferred and conducted to the ceramic plate through the box body, the original amplitude of the sound can be maintained to overcome the defects of the poor audio reception quality.

Furthermore, the throat-vibration-type sensor can be applied with a hand-free communication device, such that the hand-free communication device is incorporated with the above mentioned throat-vibration-type sensor to receive the audio signals while the user is speaking.

Accordingly, the throat-vibration-type sensor is incorporated with the hand-free communication device, wherein the box body also serves as a casing of the hand-free communication device. The box body comprises an audio output aperture, and at least one function key. The hand-free communication device further comprises a control circuit board, a sound amplification device and a battery unit. The control circuit board is arranged inside the box body to receive or transit audio signals and is wirelessly linked to an external communication device. In addition, the control circuit board is electrically connected to the audio output aperture and function key. The sound amplification device is arranged on the control circuit board, and electrically connected to the control circuit board to receive voice signals transmitted from the control circuit board as the receiver side. Therefore, the throat-vibration-type sensor incorporated with the hand-free communication device is provided and has the better audio reception property.

Accordingly, the throat-vibration-type sensor can also be incorporated with an air-conduction-type microphone directly set on the control circuit board. In addition, the sound amplification device is disposed outside of the box body, wherein the sound amplification device comprises an electrical wire and a terminal electrically connected to the audio output aperture of the box body. The sound amplification device can be speaker or headphones. The battery unit can be a rechargeable battery and can be charged through the audio output aperture.

In addition, the control circuit board comprises a socket and a connector outwardly extended to an exterior of the box body through the audio output aperture, and the functional operation unit is located at a position corresponding to the function key, such that the function key can be pressed to activate the function operating unit.

Furthermore, in order to ensure that the user can wear the hand-free communication device, the hand-free communication device comprises a binding module provided at an attachment wall of the box body, such that the user is able to attach the hand-free communication device to the user's body. For example, the binding module comprises a hook and loop fastener (“Velcro”) or comprises a binding kit which is made of soft silicon. Accordingly, the binding kit of the binding module has two through slots for enabling a strap body slidably passing therethrough, such that the strap body can be fastened to a helmet as an example.

Accordingly, the throat-vibration-type sensor incorporated with an alternative mode of the hand-free communication device is provided, wherein the hand-free communication device comprises a control box, a control circuit board, a throat-vibration-type sensor, a sound amplification device, and a battery unit, wherein the control box serves as a casing of the hand-free communication device. The control box comprises an audio output aperture, and at least one function key, wherein the control circuit board is arranged inside the box body to receive or transit audio signals. The control circuit board is wirelessly linked to an external communication device, wherein the control circuit board is electrically connected to the audio output aperture and function keys. The throat-vibration-type sensor, which is separated from the control box, comprises a box body, a ceramic sheet, a copper sheet, and an amplification circuit. The box body has an interior receiving cavity and an outer wall defining a flat platform at an inner side of the outer wall. The ceramic sheet is directly bonded on and overlapped with the platform within the receiving cavity of the box body, wherein the ceramic sheet is electrically connected to a positive electric wire. The copper sheet is bonded beneath and overlapped with the ceramic plate within the receiving cavity of the box body, wherein the copper sheet is electrically connected with a negative electric wire. The amplification circuit is electrically connected between the positive electric wire and the negative electric wire to electrically link to the ceramic sheet and the copper sheet respectively. The amplification circuit can be electrically connected to the control circuit board or can be integrated with the control circuit board. The sound amplification device is electrically connected to the control circuit board to receive voice signals transmitted from the control circuit board to form a receiver end. The battery unit is supported inside the box body and is electrically connected to the control circuit board. Therefore, the throat-vibration-type sensor is combined with the hand-free communication device to enhance the audio reception quality.

In addition, the sound amplification device comprises an electrical wire and a terminal electrically connected to the audio output aperture of the control box, so as to electrically connect to the control circuit board. In particular, the sound amplification device can be a speaker or a headphone. The battery unit is a rechargeable battery which can be charged through the audio output aperture.

The control circuit board comprises a socket and at least one functional operating unit. The socket has a connector outwardly extended to an exterior of the control box through the audio output aperture, and the functional operation unit is located at a position corresponding to the function key, such that the function key can be pressed to activate the function operating unit.

Furthermore, in order to ensure that the user can wear the hand-free communication device, the hand-free communication device comprises a binding module provided at an attachment wall of the box body, such that the user is able to attach the hand-free communication device to the user's body. For example, the binding module comprises a hook and loop fastener (“Velcro”) or comprises a binding kit which is made of soft silicon. Accordingly, the binding kit of the binding module has two through slots for enabling a strap body slidably passing therethrough, such that the strap body can be fastened to a helmet as an example.

Accordingly, the present invention provides an improved throat-vibration-type sensor, wherein the ceramic sheet is applied to be directly bonded to the inner side of the box body, so as to omit the conduction medium such as foam bodies and springs. Therefore, the present invention not only reduces the volume and thickness of the throat-vibration-type sensor, but also guides the sound vibrations propagated to the box body directly and further directly transferred to the ceramic sheet, thereby increasing the sensitivity of the audio reception.

In addition, the throat-vibration-type sensor can be combined with the hand-free communication device to serve as a hand-free voice communication system, so as to improve the sensitivity of the audio reception to fight the recognition defects of speech signal which cause the wind shear sound by the rapid movement of the user, and enhance the effectiveness of the present invention.

Additional advantages and features of the invention will become apparent from the description which follows, and may be realized by means of the instrumentalities and combinations particular point out in the appended claims.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a frequency response diagram of a conventional throat-vibration-type microphone having foam bodies.

FIG. 2 is a frequency response diagram of another conventional throat-vibration-type microphone having springs.

FIG. 3 is an exploded perspective view of a throat-vibration-type sensor according to a preferred embodiment of the present invention.

FIG. 4A is a sectional view of the throat-vibration-type sensor according to the above preferred embodiment of the present invention.

FIG. 4B illustrates an alternative mode of the throat-vibration-type sensor according to the above preferred embodiment of the present invention, illustrating an amplification circuit arranged inside a box body.

FIG. 5 is a frequency response diagram of the throat-vibration-type sensor according to the above preferred embodiment of the present invention.

FIG. 6 is an exploded view of the throat-vibration-type sensor incorporating with a hand-free communication device according to the above preferred embodiment of the present invention.

FIG. 7 is a perspective view of the hand-free communication device according to the above preferred embodiment of the present invention.

FIG. 8 is a sectional view of the hand-free communication device according to the above preferred embodiment of the present invention.

FIG. 9 is a perspective view of the hand-free communication device according to the above preferred embodiment of the present invention, illustrating a binding module incorporated with the hand-free communication device.

FIG. 10 is a perspective view of the hand-free communication device according to the above preferred embodiment of the present invention, illustrating an alternative mode of the binding module incorporated with the hand-free communication device.

FIG. 11 illustrates an alternative mode of the hand-free communication device according to a preferred embodiment of the present invention.

FIG. 12 is a sectional view of the alternative mode of the hand-free communication device according to the above preferred embodiment of the present invention, illustrating a binding module incorporated with the hand-free communication device.

FIG. 13 is a sectional view of the alternative mode of the hand-free communication device according to the above preferred embodiment of the present invention, illustrating an alternative mode of the binding module incorporated with the hand-free communication device.

### DETAILED DESCRIPTION OF THE PREFERRED EMBODIMENT

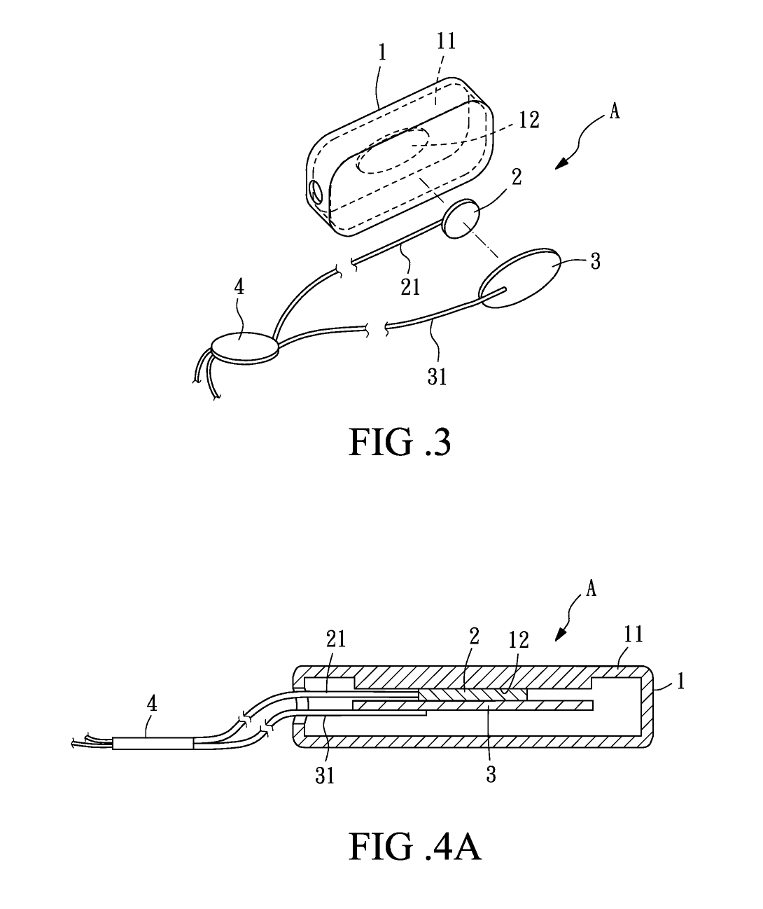

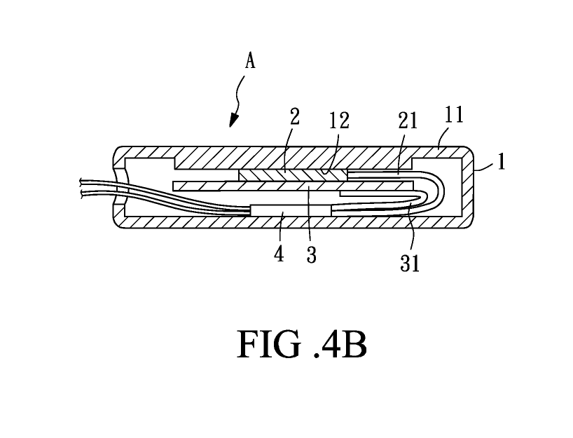

Referring to FIG. 3 and FIG. 4A of the drawings, a throat-vibration-type sensor A (a throat-vibration-type microphone) according to a preferred embodiment of the present invention is illustrated, wherein the throat-vibration-type sensor A comprises a box body 1, a ceramic sheet 2, a copper sheet 3 and an amplification circuit 4.

The box body 1 has an interior receiving cavity and an outer wall 11 defining a flat platform 12 at an inner side of the outer wall 11. As shown in FIG. 4A, the platform 12 is protruded from the inner side of the outer wall 11.

The ceramic sheet 2 is directly bonded on and overlapped with the platform 12 within the receiving cavity of the box body 1, wherein the ceramic sheet 2 is electrically connected to a positive electric wire 21 which is extended out of the box body 1.

The copper sheet 3 is bonded beneath and overlapped with the ceramic plate 2 within the receiving cavity of the box body 1, wherein the copper sheet 3 is electrically connected with a negative electric wire 31 which is extended out of the box body 1.

The amplification circuit 4 is electrically connected between the positive electric wire 21 and the negative electric wire 31 to electrically link to the ceramic sheet 2 and the copper sheet 3 respectively, wherein the amplification circuit 4 can be disposed outside the box body 1 (as shown in FIG. 3 and FIG. 4A), or can be placed inside the box body 1 (as shown in FIG. 4B).

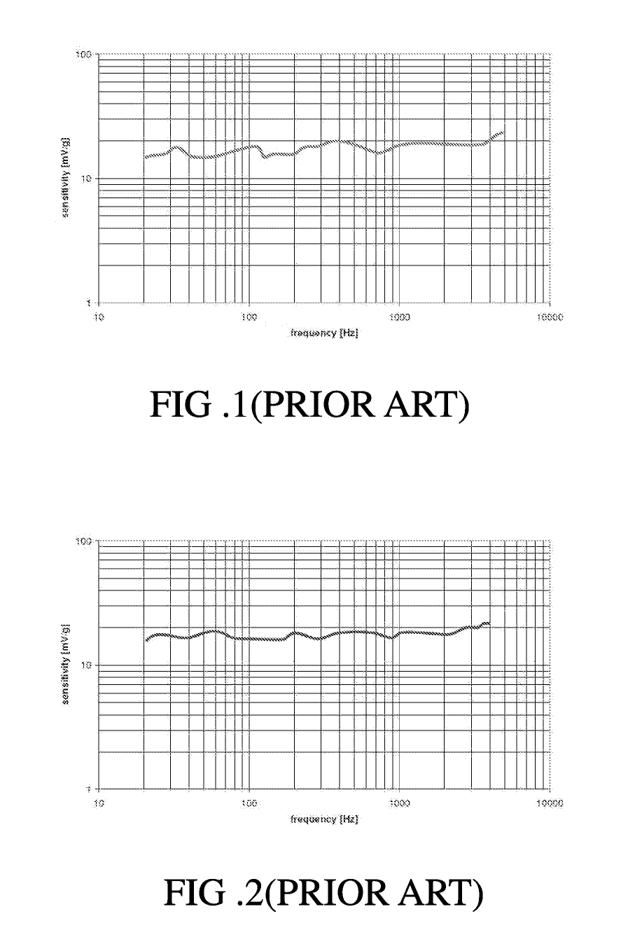

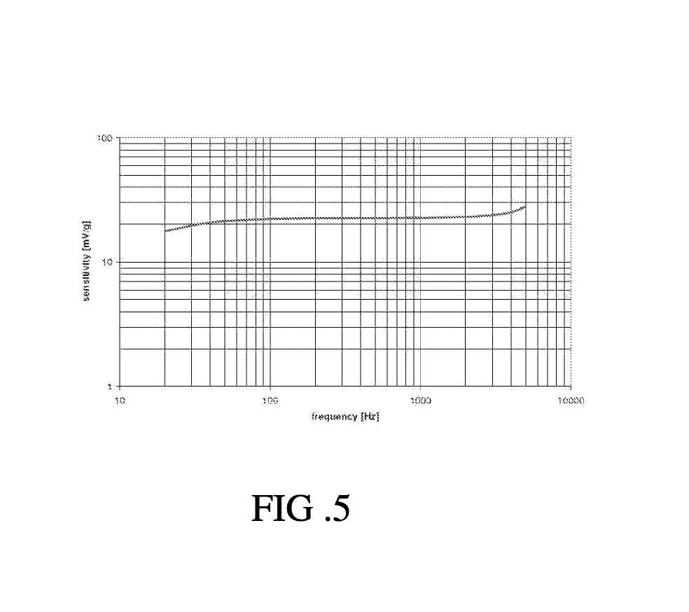

Accordingly, the feature of the throat-vibration-type sensor A is that the ceramic sheet 2 is directly affixed onto the platform 12 within the receiving cavity of the box body 1, so as to omit the conventional conduction medium, i.e. foam bodies or springs. Therefore, the sound vibration is directly transferred and conducted to the ceramic plate 2 through the box body 1. Since no conventional conduction medium is provided in the present invention, it can prevent the offset of the sound amplitude resulting of the audio distortion and low in sound sensitivity. FIG. 5 shows the frequency response diagram for the throat-vibration-type sensor A, wherein comparing with the prior art of the FIG. 1 and FIG. 2, the test data shows the throat-vibration-type sensor A of the present invention has almost zero audio distortion effect and has the high quality of audio reception ability, so as to overcome the poor audio reception in the prior arts. In other words, comparing with the prior art having the conduction medium, the present invention intentionally replace the conduction medium for improving the function of the present invention. Since the conduction medium has the disadvantages of the unevenness three-dimensional structure, the unevenness material properties, and the degradation of the material characteristics in the actual manufacturing process, the opportunities of the audio reception distortion for the frequency response of the throat-vibration-type sensor is unpredictably increased. It is preferred to replace the medium, so the present invention not only has fewer components, but also has simple in structure. The manufacturing process thereof will be simplified and changeable to improve the quality and the progressive properties of the throat-vibration-type sensor A.

The throat-vibration-type sensor A is applied with a hand-free communication device B (or other communication devices, such as wireless intercom device) to constitute a speaker terminal for receiving voice signals when a user is speaking.

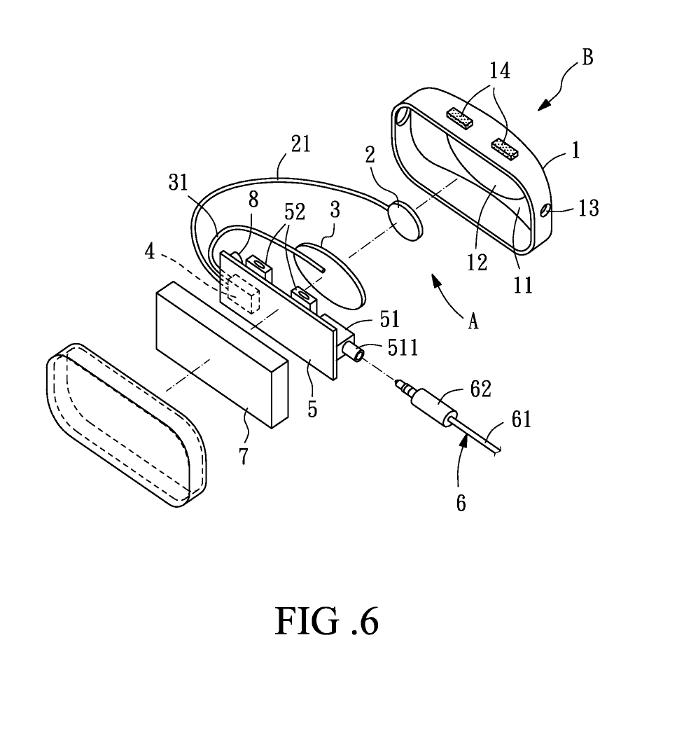

Referring to FIG. 6 to FIG. 8 of the drawings, the throat-vibration-type sensor A incorporated with the hand-free communication device B according to the preferred embodiment of the present invention is illustrated, wherein the structure of the throat-vibration-type sensor A is the same as the above mentioned structure. In particular, the box body 1 also serves as a casing of the hand-free communication device B. Accordingly, the box body 1 comprises an audio output aperture 13 and at least one function key 14, wherein the function key 14, which can be made of soft rubber, is securely mounted on the box body 1. The hand-free communication device B comprises a control circuit board 5, a sound amplification device 6 and a battery unit 7.

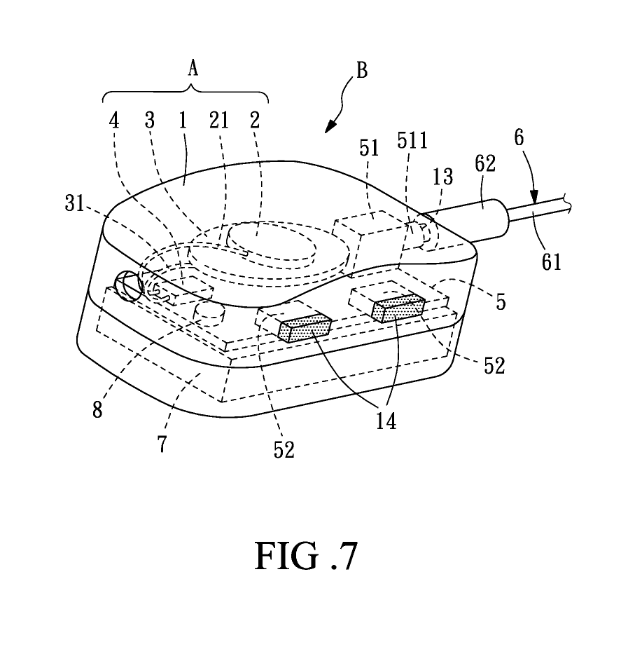

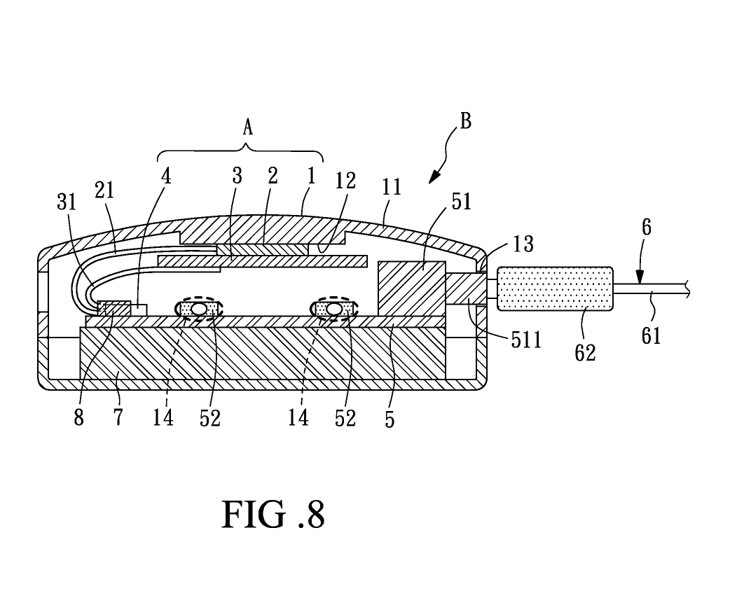

The control circuit board 5 is arranged inside the box body 1, and is positioned below the copper sheet 3, wherein the control circuit board 5 is arranged to receive or transit audio signals, and wirelessly linked to an external communication device (such as mobile phones). In addition, the control circuit board 5 is electrically connected to the audio output aperture 13 and function key 14. The control circuit board 5 comprises a terminal (jack) 51 and at least one functional operating unit 52 (preferably two functional operating units 52 as shown in FIG. 6), wherein the terminal (jack) 51 has a connector 511 outwardly extended to an exterior of the box body 1 through the audio output aperture 13, as shown in FIG. 8, and the functional operation unit 52 is located at a position corresponding to the function key 14, such that the function key 14 can be pressed to activate the function operating unit 52, as shown in FIG. 7. In addition, the throat-vibration-type sensor A can be incorporated with an air-conduction-type microphone 8 as an example, that the air-conduction-type microphone 8 can be directly provided on the control circuit board 5 while the amplification circuit 4 of the throat-vibration-type sensor A is arranged on the control circuit board 5.

The sound amplification device 6, which can be a speaker or a headphone, is disposed outside the box body 1, wherein the sound amplification device 6 comprises an electrical wire 61 and a terminal 62 electrically connected to the audio output aperture 13 of the box body 1, so as to electrically connect to the control circuit board 5. The sound amplification device 6 is adapted to receive voice signals transmitted from the control circuit board 5 to form a receiver end.

The battery unit 7 is supported inside the box body 1 at a bottom side of the control circuit board 5, wherein the battery unit 7 is electrically connected to the control circuit board 5. In addition, the battery unit 7 is a rechargeable battery which can be charged by the audio output aperture 13.

Accordingly, the throat-vibration-type sensor A receives the audio signals from the user when speaking, while the sound amplification device 6 receives the audio signals from the control circuit board 5 to serve as a speaker module, so as to constitute the hand-free communication device B. Therefore, the audio reception of the present invention can be improved by throat-vibration-type sensor A. The voice signals still can be recognized by the throat-vibration-type sensor even though the rapid movement of the user and the wind shear sound, so as to enhance the effectiveness of the present invention.

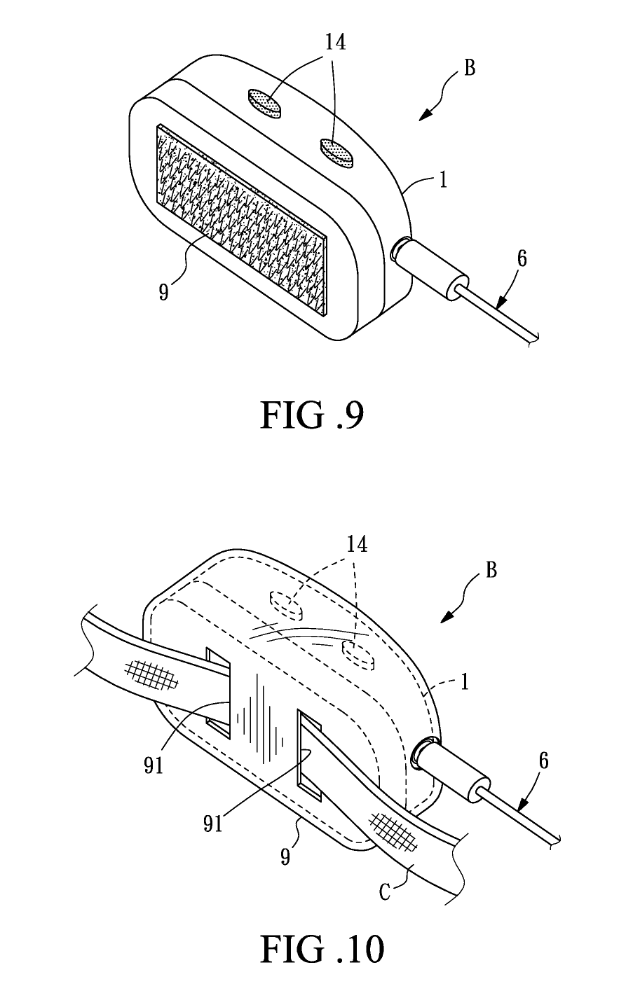

In addition, in order to ensure that the user can wear the hand-free communication device B, the hand-free communication device B comprises a binding module 9 provided at an attachment wall of the box body 1, such that the user is able to detachably attach or mount the hand-free communication device B to the user's body. For example, the binding module 9 comprises a hook and loop fastener (“Velcro”) as shown in FIG. 9 or comprises a binding kit which is made of soft silicon as shown in FIG. 10. Accordingly, the binding kit of the binding module 9 has two through slots 91 for enabling a strap body C slidably passing therethrough, as shown in FIG. 10, such that the strap body C can be fastened to a helmet as an example.

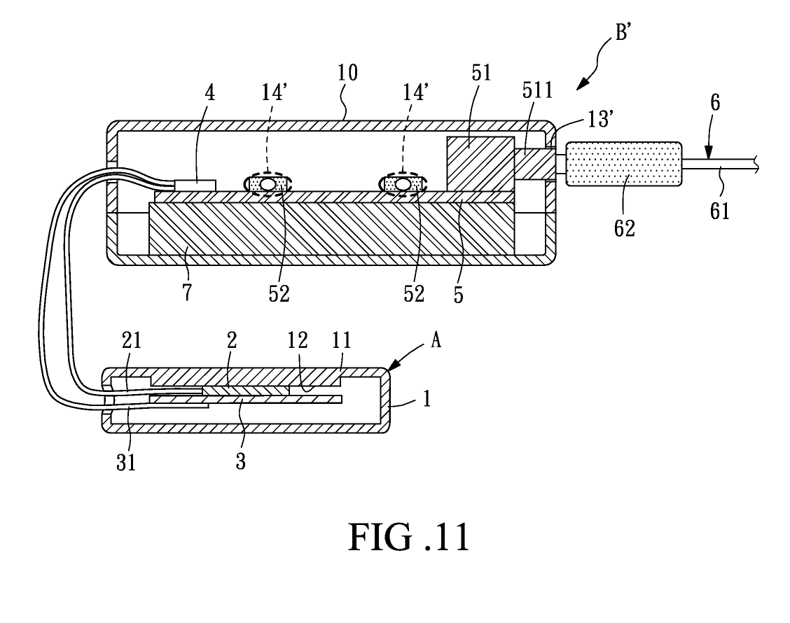

Referring to FIG. 11 of the drawings, a throat-vibration-type sensor A incorporated with an alternative mode of the hand-free communication device B′, wherein the hand-free communication device B′ comprises a control box 10, a control circuit board 5, a sound amplification device 6 and a battery unit 7. The throat-vibration-type sensor A has the same structure as the above mentioned preferred embodiment, but it is separated from the hand-free communication device B′. In particular, the throat-vibration-type sensor A is electrically connected with the hand-free communication device B′ via a cable connection.

The hand-free communication device B′ comprises a control box 10 as a casing thereof, wherein the control box 10 has an interior cavity, an audio output aperture 13′, and at least one of function key 14′ (preferably two function keys 14′ as shown in FIG. 11), wherein the function key 14′, which can be made of soft rubber, is securely mounted on the control box 10.

The control circuit board 5 is received in the interior cavity of the control box 10, wherein the control circuit board 5 is adapted to receive or transit audio signals, and is wirelessly linked to an external communication device (such as mobile phones). The control circuit board 5 is electrically connected to the audio output aperture 13′ and function keys 14′, wherein the control circuit board 5 comprises a terminal (jack) 51 and at least one functional operating unit 52 (preferably two functional operating units 52 as shown in FIG. 11). The terminal (jack) 51 has a connector 511 outwardly extended to an exterior of the control box 10 through the audio output aperture 13′, and the functional operation unit 52 is located at a position corresponding to the function key 14′, such that the function key 14′ can be pressed to activate the function operating unit 52. In addition, the throat-vibration-type sensor A further comprises an amplification circuit 4 integrated with the control circuit board 5.

The sound amplification device 6, which can be a speaker or a headphone, is disposed outside of the control box 10, wherein the sound amplification device 6 comprises an electrical wire 61 and a terminal 62 electrically connected to the audio output aperture 13′ of the control box 10, so as to electrically connect to the control circuit board 5. The sound amplification device 6 is adapted to receive voice signals transmitted from the control circuit board 5 to form a receiver end.

The battery unit 7 is supported inside the control box 10 at a bottom side of the control circuit board 5, wherein the battery unit 7 is electrically connected to the control circuit board 5. In addition, the battery unit 7 is a rechargeable battery which can be charged by the audio output aperture 13′.

Accordingly, the throat-vibration-type sensor A receives the audio signals from the user speaking, while the sound amplification device 6 receives the audio signals from the control circuit board 5 to serve as a speaker module, so as to constitute the hand-free communication device B′. Therefore, the audio reception of the present invention can be improved by throat-vibration-type sensor A. The voice signals still can be recognized by the throat-vibration-type sensor even though the rapid movement of the user and the wind shear sound, so as to enhance the effectiveness of the present invention.

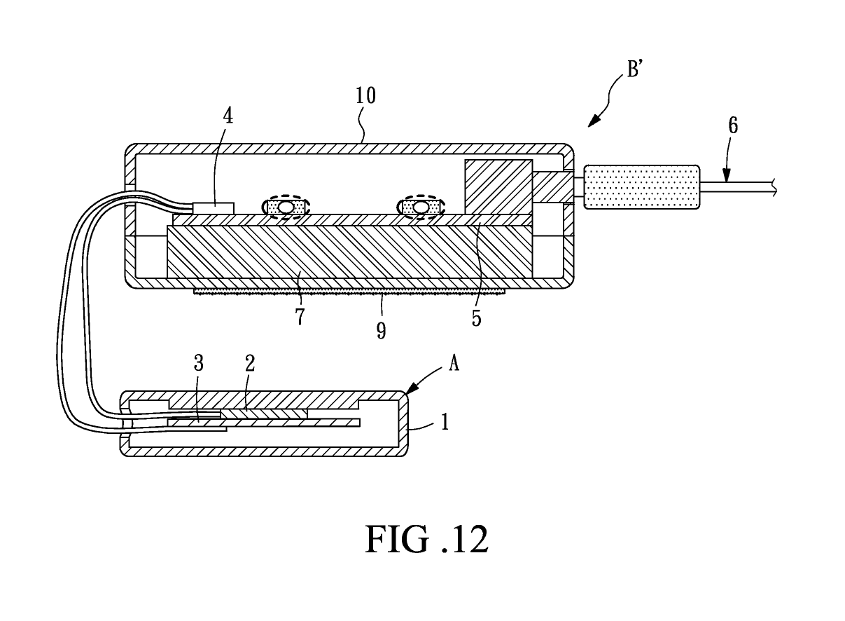

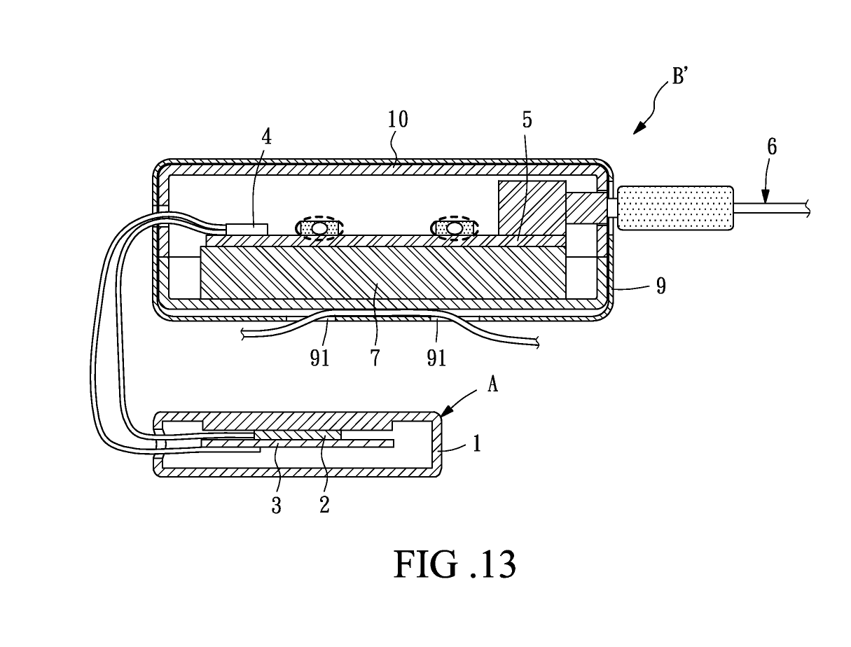

In addition, in order to ensure that the user can wear the hand-free communication device B′, the hand-free communication device B′ comprises a binding module 9 provided at an attachment wall of the box body 1, such that the user is able to detachably attach or mount the hand-free communication device B to the user's body. For example, the binding module 9 comprises a hook and loop fastener (“Velcro”) as shown in FIG. 12 or comprises a binding kit which is made of sot silicon as shown in FIG. 13. Accordingly, the binding module 9 has two through slots 91 for enabling a strap body C slidably passing therethrough, as shown in FIG. 13, such that the strap body C can be fastened to a helmet as an example.

According to the above mentioned hand-free communication devices B and B′, the control circuit board 5 can be wirelessly linked to the external device, wherein the hand-free communication devices B and B′ can be implemented via an one to one mode, or one to more mode.

According to the preferred embodiment of the present invention, the improved throat-vibration-type sensor A is provided, wherein the ceramic sheet 2 is applied to be directly bonded to the inner side of the box body 1, so as to omit the conduction medium such as foam bodies and springs. Therefore, the present invention invention not only reduces the volume of the throat-vibration-type sensor A, but also reduces the thickness thereof. In particular, the sound vibrations are directly transferred to the box body 1 and further are directly transferred to the ceramic sheet 2, thereby increasing the sensitivity of the audio reception. In addition, the throat-vibration-type sensor A can be combined with the hand-free communication device B, B′ to serve as a hand-free voice communication system, so as to improve the sensitivity of the audio reception and enhance the effectiveness of the present invention. The above mentioned improved features are the main objectives of the present invention.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A throat-vibration-type sensor, comprising:
a box body having an interior receiving cavity and an outer wall which defines a flat platform at an inner side of said outer wall;
a ceramic sheet received within said receiving cavity of said box body and directly bonded to said platform, wherein said ceramic sheet is electrically connected to a positive electric wire;
a copper sheet received within said receiving cavity of said box body and bonded beneath said ceramic plate, wherein said copper sheet is electrically connected with a negative electric wire; and
an amplification circuit electrically connected with said positive electric wire and said negative electric wire to electrically connect with said ceramic sheet and said copper sheet respectively.

2. The throat-vibration-type sensor, as recited in claim 1, wherein said amplification circuit is arranged outside or inside of said box body.

3. A hand-free communication device, comprising:
a throat-vibration-type sensor for receiving audio signals from a user, said throat-vibration-type sensor comprising:
a box body having an interior receiving cavity and an outer wall which defines a flat platform at an inner side of said outer wall, wherein said box body further comprises an audio output aperture, and at least one of function key;
a ceramic sheet received within said receiving cavity of said box body and directly bonded to said platform, wherein said ceramic sheet is electrically connected to a positive electric wire;
a copper sheet received within said receiving cavity of said box body and bonded beneath said ceramic plate, wherein said copper sheet is electrically connected with a negative electric wire; and
an amplification circuit electrically connected with said positive electric wire and said negative electric wire to electrically connect with said ceramic sheet and said copper sheet respectively;
a control circuit board arranged inside said box body to receive or transit audio signals, wherein said control circuit is adapted for wirelessly linking to an external communication device, wherein said control circuit is electrically connected to said audio output aperture and function keys, and said amplification circuit is arranged on said control circuit board;
a sound amplification device electrically connect to said control circuit board for receiving audio signals from said control circuit board; and
a battery unit received in said box body and electrically connected to said control circuit board.

4. The hand-free communication device, as recited in claim 3, wherein said throat-vibration sensor is incorporated with an air-conduction-type microphone.

5. The hand-free communication device, as recited in claim 4, wherein said air-conduction-type microphone is arranged on said control circuit board.

6. The hand-free communication device, as recited in claim 3, wherein said sound amplification device is disposed outside said box body, wherein said sound amplification device has an electrical wire and a terminal electrically connected to said audio output aperture of said box body.

7. The hand-free communication device, as recited in claim 6, wherein said sound amplification device is a speaker or a speakerphone.

8. The hand-free communication device, as recited in claim 3, wherein said battery unit is a rechargeable battery that is charged through said audio output aperture.

9. The hand-free communication device, as recited in claim 3, wherein said control circuit board comprises a socket having a connector outwardly extended to an exterior of said box body through said audio output aperture.

10. The hand-free communication device, as recited in claim 3, wherein said control circuit board comprises at least one functional operating unit located at a position corresponding to said function key, such that said function key is pressed to activate said function operating unit.

11. The hand-free communication device, as recited in claim 3, further comprising a binding module provided at said box body for mounting to a body of said user.

12. The hand-free communication device, as recited in claim 11, wherein said binding module comprises a hook and loop fastener.

13. The hand-free communication device, as recited in claim 11, wherein said binding module comprises a binding kit which has two through slots for enabling a strap body slidably passing therethrough.

14. A hand-free communication device, comprising:
a control box having an interior cavity, an audio output aperture, and at least one function key;
a control circuit board arranged inside said control box to receive or transit audio signals, wherein said control circuit board is arranged for wirelessly linking to an external communication device, wherein said control circuit board is electrically connected to said audio output aperture and said function key,
a throat-vibration-type sensor comprising:
a box body having an interior receiving cavity and an outer wall which defines a flat platform at an inner side of said outer wall;
a ceramic sheet received within said receiving cavity of said box body and directly bonded to said platform, wherein said ceramic sheet is electrically connected to a positive electric wire;
a copper sheet received within said receiving cavity of said box body and bonded beneath said ceramic plate, wherein said copper sheet is electrically connected with a negative electric wire; and
an amplification circuit electrically connected with said positive electric wire and said negative electric wire to electrically connect with said ceramic sheet and said copper sheet respectively;
a sound amplification device electrically connect to said control circuit board for receiving audio signals from said control circuit board; and
a battery unit arranged in the interior of said box body and electrically connected to said control circuit board.

15. The hand-free communication device, as recited in claim 14, wherein said throat-vibration-type sensor is located outside said control box, and said sound amplification device is integrated with said control circuit board.

16. The hand-free communication device, as recited in claim 14, wherein said sound amplification device, which is disposed outside said control box, has an electrical wire and a terminal electrically connected to said audio output aperture of said control box.

17. The hand-free communication device, as recited in claim 16, wherein said sound amplification device is a speaker or a speakerphone.

18. The hand-free communication device, as recited in claim 14, wherein said battery unit is a rechargeable battery that is charged through said audio output aperture.

19. The hand-free communication device, as recited in claim 14, wherein said control circuit board comprises a terminal having a connector outwardly extended to an exterior of said box body through said audio output aperture.

20. The hand-free communication device, as recited in claim 14, wherein said control circuit board comprises at least one functional operating unit located at a position corresponding to said function key, such that said function key is pressed to activate said function operating unit.

21. The hand-free communication device, as recited in claim 14, further comprising a binding module provided at said box body for mounting to a body of said user.

22. The hand-free communication device, as recited in claim 21, wherein said binding module comprises a hook and loop fastener.

23. The hand-free communication device, as recited in claim 21, wherein said binding module comprises a binding kit which has two through slots for enabling a strap body slidably passing therethrough.
